(19) United States
(12) Patent Application Publication
(10) Pub. No.: US 2010/0014833 A1
(43) Pub. Date: Jan. 21, 2010

(54) CONTENT PROTECTION USING A PROTECTION STREAM

(75) Inventors: Ilija Pjanovic, Eindhoven (NL); Serhiy Tkachenko, Geldrop (NL); Victor Shcherbatyuk, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/721,470

(22) PCT Filed: Dec. 14, 2005
(86) PCT No.: PCT/IB05/54233

§ 371 Date: Aug. 27, 2009

(30) Foreign Application Priority Data
Dec. 20, 2004 (EP) 04106708.3

(51) Int. Cl. H04N 7/00

(52) U.S. Cl. 386/95; 386/126; 386/E05.001

(57) ABSTRACT

The invention relates to a portable storage medium, a media player, a method, and a signal for disturbing the perception of content provided in a first media stream. The first media stream is combined with a second media stream in at least one transport stream. The media player includes a control unit, which receives a user selection of reproducing content provided in the first media stream, (step 40), selects the second media stream for presentation together with the first media stream, (step 42), determines if there is a user-selectable object in the second stream having an action associated with it, (step 50), and at least orders the automatic performance of the action associated with the user-selectable object found, (step 52), in order to disturb the perception of content provided in the first media stream.

### FIELD OF THE INVENTION

The present invention generally relates to protection of content provided in media streams and more particularly to a portable storage medium, a media player, a signal and a method of disturbing the perception of content provided in a first media stream.

### BACKGROUND OF THE INVENTION

In recent years a number of standards for recording multimedia data on portable storage mediums have been developed, for example, DVD (Digital Versatile Disc) and Blu-ray disc video. Different media streams are provided, which are multiplexed with each other into transport streams. A user can then also select the streams to be presented, for example, different audio language streams and different subtitle streams, depending on the relevant country.

When providing content on such a disc, it is advantageous to provide a limited version of the content, which limited version forms a subset of the whole content. This limited version can then be distributed freely for informing potential customers of some of the key features of the content. Once a customer purchases the content, he is given a full version of the content. This is normally done by providing separate discs, one with the limited version and the other with the full version. This is both a complex and expensive way of providing the content. It would therefore be beneficial if both the limited and full versions of the content could be provided together.

One way of doing so is presented in US-2003/0163724, wherein a masking effect is provided as an overlay, interruption, interference, disturbance or disorientation on an information product, for which an information object can be provided as image, video, audio, etc. The information product is provided on a server and streamed to a user, but can also be provided on a CD ROM storage media.

In view of the prior art, it would be advantageous to provide an improved way of disturbing the perception of content provided in a transport stream.

### OBJECT AND SUMMARY OF THE INVENTION

It is therefore an object of the present invention to provide an improved way of disturbing the perception of content provided in a transport stream.

According to a first aspect of the present invention, this object is achieved by a portable storage medium to be used in a media player for disturbing the perception of content provided in a first media stream, the medium having stored thereon:

at least one transport stream comprising the first media stream combined with at least a second media stream having at least one embedded user-selectable object, wherein the object is set to automatically provide an action disturbing the perception of content in the first stream when the object in the second stream is being processed.

According to a second aspect of the present invention, the object is also achieved by a media player for disturbing the perception of content provided in a first media stream, said first media stream being combined with at least a second media stream in a transport stream, the media player comprising: a control unit arranged to:
receive a user selection of reproducing content provided in the first media stream,
select the second media stream for presentation together with the first media stream,
determine if there is a user-selectable object in the second stream having an action associated with it, and
at least order automatic performance of the action associated with a user-selectable object found, in order to disturb the perception of content provided in the first media stream.

According to a third aspect of the present invention, the object is also achieved by a method of disturbing the perception of content provided in a first media stream, said first media stream being combined with at least a second media stream in a transport stream, the method comprising the steps of:

receiving a user selection of reproducing content provided in the first media stream,

selecting the second media stream for presentation together with the first media stream,

determining if there is a user-selectable object in the second stream having an action associated with it, and

automatically performing the action associated with the user-selectable object found, in order to disturb the perception of content provided in the first media stream.

According to a fourth aspect of the present invention, this object is also achieved by a signal for use in a media player that allows disturbing the perception of content provided in a first media stream, comprising:

at least one transport stream comprising the first media stream combined with at least a second media stream having at least one embedded user-selectable object, wherein the object is set to automatically provide an action disturbing the perception of content in the first stream when the object in the second stream is being processed.

Disturbing the perception of content is realized in a simple way by means of the present invention, using a protection stream created by using an existing stream type provided in a transport stream. In this way, it is possible to avoid the use of additional complex measures for disturbing content. The invention also allows the use of the same transport stream for providing pre-view and full copies of content, which reduces the production costs of, for instance, portable storage mediums comprising such signals. Furthermore, there is great freedom of selecting disturbing measures. Since the measures are provided in an existing transport stream structure, the additional storage space required for such measures is limited.

As defined in claim 2, the object is set to recur regularly in the second stream. This feature allows the frequent provision of measures discouraging a user from removing them, and allows enhanced protection of content.

As defined in claim 3, the object is set to generate a sound, when it is being processed. This feature allows the provision of a measure that occupies a very limited space, which at the same time provides effective disturbing of audio content.

As defined in claim 4, there is an embedded command associated with the object. This feature allows the provision of a range of measures for disturbing the perception of content, and thus allows great freedom of selecting protective measures.

As defined in claim 5, a user is not allowed to change a command set for an object. This feature guarantees that a user does not switch off a protective measure.

As defined in claim 7 the first media stream is a video stream and the command selects a third video stream of the same content with a lower quality. This feature has the advantage of allowing the use of different angles of video, which are provided in order to disturb the perception of content. In this way, the measure for disturbing the perception of content can be provided with different codes of the same content, which is a very limited additional effort that can be implemented at low additional cost.

As defined in claim 8, the first media stream is a video stream and the command selects a third stream comprising additional visual information. This feature has the advantage of using already existing additional graphics and/or subtitle streams for disturbing the perception of content.

As defined in claim 9, the first stream is an audio stream that is combined with a video stream and the command selects a third stream which is also an audio stream. This feature has the advantage of allowing the use of existing audio streams normally provided for other purposes for disturbing the perception of sound.

As defined in claim 10, a medium comprises a computer program code for providing a command structure for selecting and playing streams. This feature has the advantage of allowing the content provider full control of the measures performed for disturbing the perception of content.

According to an optional feature of the present invention, a time-out period is associated with user inputs in relation to the object, wherein the action is set to be performed as a default action when the time-out period expires and is set to be short enough so that a user is unable to provide inputs in relation to the object.

The basic idea of the present invention is to use an interactive stream that comprises embedded user-selectable objects, for which type of stream many transport streams already accommodate space. The objects of the interactive stream are then used for disturbing the perception or masking of the content provided in the transport stream. In this way, it is possible to avoid the use of additional complex measures for disturbing content.

The above-mentioned and other aspects of the invention are apparent from and will be elucidated with reference to the embodiments described hereinafter.

### BRIEF DESCRIPTION OF THE DRAWINGS

The present invention will be further described with reference to the accompanying drawings, in which:

FIG. 1 schematically shows clips of media data together with a command structure provided for playing these clips,

FIG. 2 schematically shows a clip comprising a transport stream together with a corresponding clip information file,

FIGS. 3a and b schematically show two EP-tables provided in the clip information file of FIG. 2,

FIG. 4 schematically shows a stream allocation table associated with a stream control module of FIG. 1,

FIG. 5 schematically shows a user-operation table also associated with a stream control module of FIG. 1,

FIG. 6 schematically shows the presentation of an interactive graphics stream on top of a video stream,

FIG. 7 schematically shows the relationship between the different states of a button provided in the interactive graphics stream,

FIG. 8 schematically shows a portable storage medium according to the present invention, comprising the clips together with software for providing the command structure both shown in FIG. 1,

FIG. 9 is a block diagram of a media player arranged to provide the command structure of FIG. 1 as well as play the clips also provided in FIG. 1, and

FIG. 10 is a flow chart of a method of disturbing the perception of content according to the present invention.

### DESCRIPTION OF EMBODIMENTS

The present invention generally relates to disturbing the perception of media content that can be provided on a portable storage medium. A portable storage medium is normally an optical disc. However, other types of mediums are also possible for use in the present invention, such as, for instance, memory sticks. Before the details of disturbing the perception of media content according to the present invention are further described, the general structure of the way in which information is provided on such a storage medium and how it is used for controlling media streams will be described first.

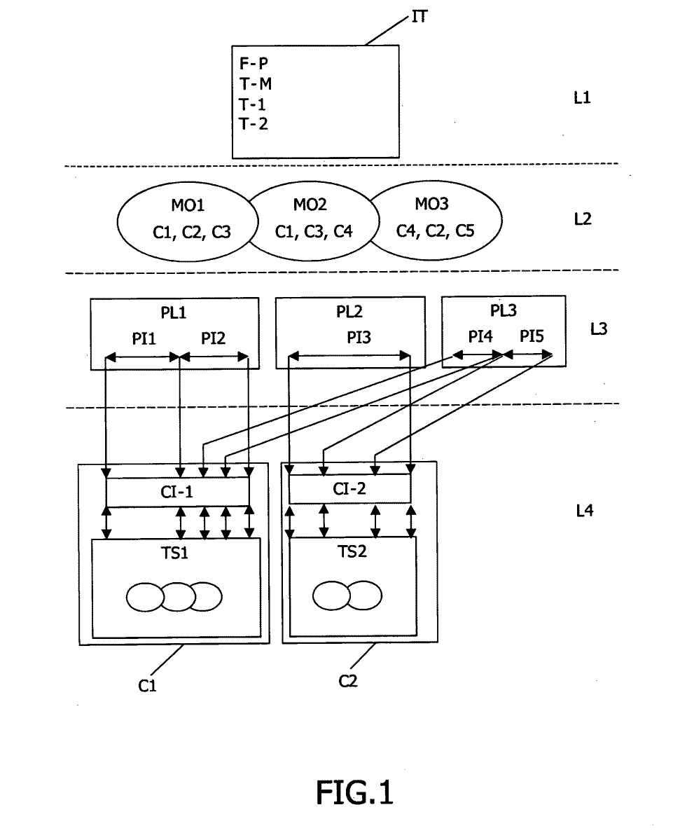

FIG. 1 is a schematic drawing of a media content command structure provided by a computer program code on a portable storage medium. The content command structure is operative when the computer program code is loaded in a memory and run on a suitable processor, which is normally present in the control unit of a media player. The structure is grouped into different layers L1, L2 and L3 that make up a structure for a playing control unit. Another layer L4 provides media content which is controlled by the playing control unit. A first top layer L1 includes an Index table IT comprising a first playback item FP, a top menu item T-M, a first title item T-1, and a second title item T-2. This layer L1 is adapted to communicate with a user interface via which a user can access the media content on the medium. This top layer L1 covers a second layer L2 comprising a number of command modules, which are here also called Movie Objects MO1, MO2, MO3. These movie objects MO1, MO2 and MO3 are activated by items in the index table IT in the top layer L1 on the basis of user inputs. A third layer L3 comprises a number of media stream control modules in the form of Play Lists PL1, PL2 and PL3 each having one or more play item control modules PI, which will hereinafter be denoted as play items. The play items PI point at data in a fourth layer L4, which data is provided in the form of clips C1 and C2 each comprising a transport stream TS1 and TS2 of multiplexed media streams together with corresponding overhead data in the form of clip information files CI-1 and CI-2.

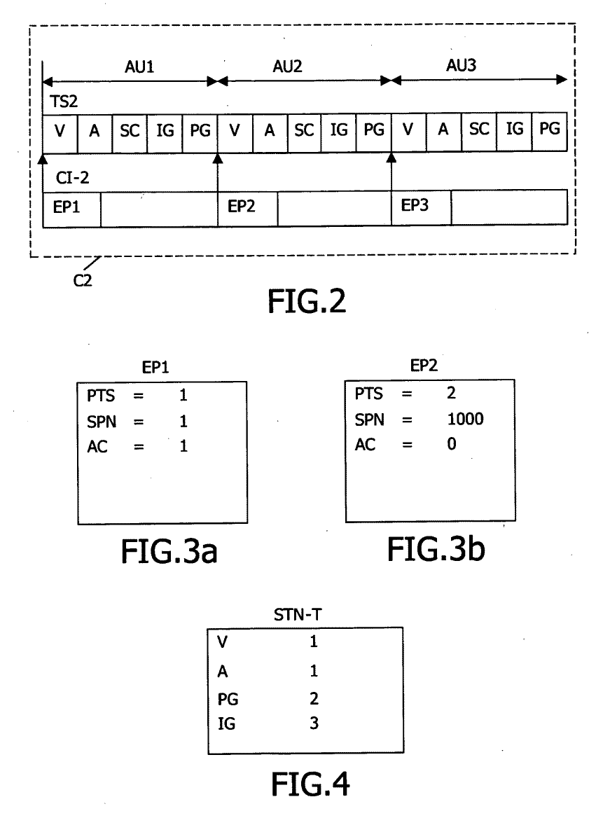

Clip information files and transport streams are described with reference to FIG. 2, which shows one transport stream TS2 together with a corresponding clip information file CI-2. A transport stream TS includes MPEG coded video V packets and Dolby AC-3 coded audio packets A together with stream control packets SC, as well as interactive graphics IG and presentation graphics, and text PG packets. An interactive graphics stream will be described hereinafter. A presentation graphics and text stream provides additional graphics and text. The presentation graphics and text stream is provided as two-dimensional run-length encoded raster images together with control information for placement of images, colors, etc. The streams are divided into access units, only three of which, AU1, AU2 and AU3 are shown. It should be realized that there are normally several more access units. In order to simplify the description, each access unit only includes one packet of each type in the Figure. It should, however, be realized that in reality there are normally several packets of each type in each access unit. Furthermore, the total number of packets in the access units is preferably normalized, so that each of them includes the same amount of packets in order to simplify switch-over between different transport streams. Another term frequently used for an access unit is “frame”. The streams are provided with presentation time stamps PTS as well as source packet numbers SPN and the clip information file CI-2 includes EP-tables including information pointing at the entry and exit points of the transport streams in order to allow switch-over between different transport streams and also switch-over between different parts of the same stream.

FIG. 3A shows an example of such an EP table EP1 provided in the clip info file CI-2 and pointing at the first video packet of the first access unit AU1. Here, there is provided a first presentation time stamp PTS and a first source packet number SPN, both set to one indicating that the EP table points at the first packet in the stream, which packet is also a first packet of an access unit that is the first to be presented to a user. Here, there is also provided an angle change flag AC which is set to one, which indicates that an angle change can be performed. Angle changes will be described in more detail hereinafter. FIG. 3B shows a second EP-table associated with the second access unit AU2 and pointing at the first video packet of this access unit. This video packet has SPN number 1000 in the transport stream TS1. Here again, there is a presentation time stamp, which in this example is set to two, which indicates that the video information in this access unit will be presented directly after the video information of the first access unit. It should be noted that the presentation order may be different, depending on how the video coding was performed. Also in this case, there is provided an angle change flag AC, which is set to zero. This setting indicates that an angle change cannot be made. As is shown in FIG. 2, there is also an EP-table associated with the third access unit, which is similar in nature to the first and second access units. Furthermore, there are more EP-tables in the stream, wherein an EP-table is provided for some access units of a stream and with a small time interval between each EP-table. If a video stream is provided, the table always point at the first video packet of the access unit. If there is no video stream, the table points at the first audio packet of an access unit and if there is no video or audio stream, there is no EP table at all.

Document EP1 198 133, which is herein incorporated by reference, also describes how transport streams and clip information files can be set up and made to cooperate.

In FIG. 1, a play list PL comprises a number of play items PI, wherein a play item can point at an entry and exit location in a clip information file CI. The play list can then include several play items and, in this way, a number of transport stream sections can be made to be played after each other. FIG. 1, which is merely an example, shows that the first play list PL1 has a first play item PI pointing at a first section of the first clip C1 and a second play item PI2 pointing at a second section of the first clip C1. The second play list PL2 has a third play item PI3 pointing at the whole second clip C2, while the third play list PL3 has a fourth play item PI4 pointing at a section of the first clip C1 and a fifth item PI5 pointing at a section of the second clip C2.

Via the play list, it is further possible to select the playing of other streams that are related to a transport stream. One such seam is a text subtitle stream, which is provided as a separate transport stream that is synchronized with the main transport stream. This stream includes a number of packets including text information as well as other information such as definitions of box size, font type and size of characters. This stream also has timing positions provided in the header of each access unit. Another such stream is a different angle of the same video content, i.e. video information shot by another camera. In the present context, the other angle is provided in a different transport stream with a separate clip information file. Here, only the coded video streams differ, but at least the number of all other types of streams in the transport streams is the same and hence a play item can refer to two different video streams. In the present invention, angles will be used in a slightly different way than is normally the case.

A user can select to play the media data provided in a clip via selections made in the index table IT. Once an item is selected in the table, this item calls upon a movie-object MO, which in turn selects a play list PL. Via the play list, the actual content to be presented is selected. As mentioned above, a movie object MO is a set of commands executed by the player in which the medium is loaded, wherein one command can call upon a play list PL and order the playing of the content that this play list is pointing at. Another type of command points at another movie object. It is also possible for a movie object to point at an entry in the index table. These types of commands can then be made to jump unconditionally to another movie object, play list, entry in the index table, or resume operation after the actions performed via the index table, movie object and/or play list have been finished. It is further possible to make a jump or selection conditionally based on a comparison of different pieces of information. The movie object also includes commands such as set stream, which is applicable to the different type of streams such as video, audio, presentation graphics and text as well as the interactive graphics stream. This command sets a certain type of stream to be played when a play list is being activated. It should also be realized that there is no one-to-one relationship between movie objects and entries in the index table. An item in the index table calls upon a movie object, but there might be movie objects that items in the index table do not directly call upon.

A stream allocation table, which is also called STN table, is associated with each play item PI. FIG. 4 shows an STN table that is associated with a play item PI in FIG. 1. The table shows settings that are allowable for a transport stream of a play item, i.e. which one of the different streams of a clip a user can select and what streams in a transport stream or in other associated transport streams. The streams set in the table are the streams that are allowed for a user to play. In the table in FIG. 4, a first video stream V, a first audio stream A, a second presentation graphics and text stream PG and a third interactive graphics stream IG are allowed. A setting in the table indicates that these are the only streams allowed to be played by a play item.

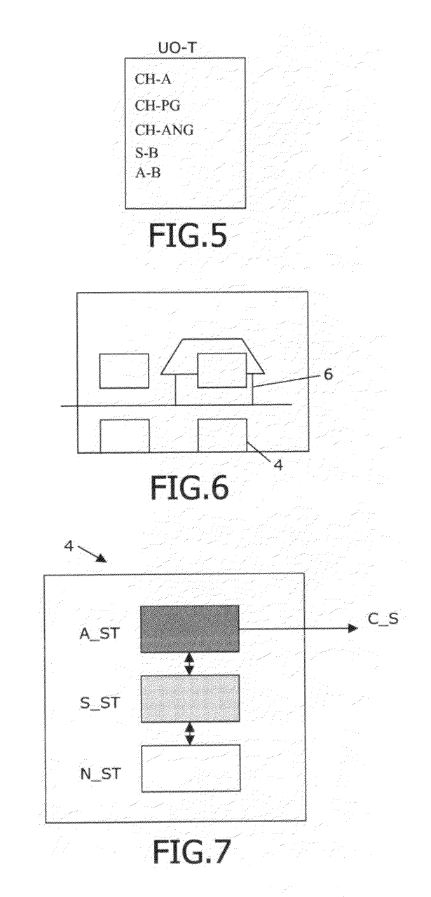

FIG. 5 shows a user-operating mask table UO-T associated with a play item. This table has a number of flags, which define if a user is allowed to make changes in relation to certain streams, wherein a first flag CH-A indicates if a user is allowed to change audio streams, a second flag CH-PG indicates if a user is allowed to change the presentation graphics and text stream, a third flag CH-ANG indicates if a user is allowed to change the angle, a fourth flag S-B indicates if a user is allowed to select a button and a fifth flag indicates if a user is allowed to activate a button. Here, the fourth and fifth flags are related to the interactive graphics stream, wherein buttons are provided. The relevance of these buttons will be described hereinafter.

The interactive graphics stream is provided as an overlay screen which can be provided on top of a video stream displaying a group of graphical objects. These graphical objects are provided as two-dimensional run-length encoded raster images. The stream also comprises control information for placement of images, colors, etc. Some objects in the stream are buttons. In a certain overlay screen, there may thus be a group of buttons, which group can be limited to one button. Each button of each screen can be associated with a command script. Because of this, a button is an object embedded in the interface graphics stream that can be selected by a user. Such an overlay screen is shown in FIG. 6, which shows a number of buttons 4 provided on top of a video image provided through MPEG coding, which video image here shows a house 6. The overlay image can be set to be displayed at different time positions indicated by time stamps in headers of the first such packet in the access units.

FIG. 7 is a schematic view of the different possible states of such a button. A button is first in a normal state N_ST awaiting activation by a user. Once a user selects the button, it transfers into a selected state S_ST, from which it can transfer into an activated state A_ST if the user activates it. An embedded command script C_S associated with the button is only invoked if a button transfers into the activated state A_ST. Furthermore, every state of a button may have a picture associated with it and the button can be made to appear transparent, semi-transparent, non-transparent or animated. It is further possible to set a presentation time for a button, that means how long it is to be presented to a user and to set a time-out period when user input in relation to a button expires, which time-out period is related to the presentation time period. Another possible setting is a default activated button and a default selected button, which settings are typically performed when a period of time for a user to activate a button and a time for selecting a button by a user expire. It is also possible to set a click sound to be generated for a button in relation to both the selected and activated states, which click sound is produced when a user selects or activates the button. There are a number of commands that can be associated with such a button. It is further possible to set a group of buttons to occur frequently in the interactive graphics stream, wherein each button can be associated with different commands. Thus, there is a number of commands associated with the buttons in the interactive graphics stream, which commands are provided in the stream itself. These commands include some of the commands provided for the movie objects, such as the set stream command, but also some other commands and settings are possible, such as branch to play item, jump to another play item in current play list and terminate playing. In normal use of the medium, the whole interactive graphics stream as well as the individual buttons provided in it can be inactivated by a user. Thus, a user can normally disable the presentation of the whole stream or disable the functionality of some or all buttons of the stream. Furthermore, a UO-T table is associated with these command scripts. It should also be realized that there may be more than one interactive graphics stream in a clip. The reason for providing an interactive graphics stream in a transport stream is to allow a user to make different selections in relation to the playing of a stream, such as change of angle, change of subtitle or any other type of selection. A click sound is provided so that a user can get the feeling that his activations and selections are registered. The present invention aims at using these features in another way.

Now that the general structure of the environment in which the invention is being implemented has been described, a description of the present invention will follow.

When a portable storage medium, such as an optical disc, is provided with media content, it is often advantageous to provide the media data so that a preview copy of the content can be provided. This might be interesting from a promotion point of view, with a potential customer getting to see and hear some of the content on the disc in order to make up his mind if a purchase is interesting or not. Traditionally, this is done by making separate copies of the content, one promotional copy with a limited content and one full copy with all of the content, provided on separate portable storage mediums or discs. One aspect of the present invention relates to providing the entire content on one disc, i.e. a disc providing both a preview copy and a full copy. However, at least the majority of the content should then be covered, blocked or in any other way made hard to perceive in order to just allow a preview. It should then be possible to remove the protection once a purchase is made.

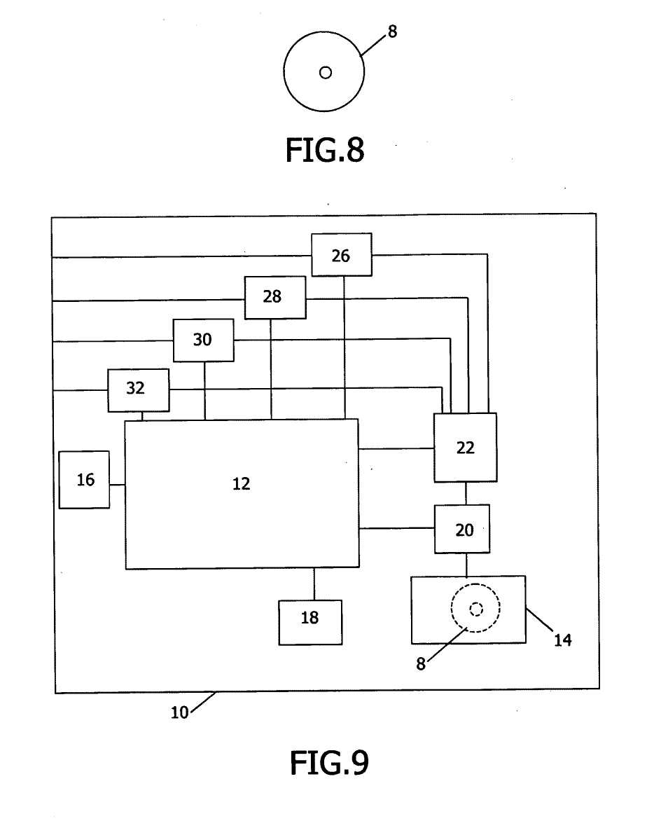

FIG. 8 shows a portable storage medium in the form of an optical disc 8 on which a computer program code enabling the provision of the command structure in layers L1, L2 and L3 of the system in FIG. 1 is stored together with the clips C1 and C2 in layer L4 of the same Figure. The command structure in layers L1 to L3 is then moved to a media player, an example of which is shown in a block diagram in FIG. 9.

The player 10 includes an optical disc drive 14 arranged to receive the disc 8. The device also includes a control unit 12 and a user interface 16 connected to the control unit 12. The disc drive 14 is connected to a reading unit 20 for reading information on the disc 8. The reading unit 20 is further connected to the control unit 12 and to a stream-separating unit 22, which is arranged to receive clips, remove clip information files and supply them to the control unit 12 and separate or demultiplex the media streams that are provided in transport streams into separate media streams. The stream-separating unit 22 is therefore connected to a video decoding unit 32 for decoding MPEG video signals, an audio decoding unit 30 for decoding audio, a graphics processing unit 28 for processing presentation graphics and text streams and to an interactive graphics processing unit 26 for processing interactive graphics streams. The control unit 12 is also connected to all of these units 32, 30, 28 and 26 for controlling them as well as to a status register 18, which stores current status information of the player 10 such as current angle, current audio and current play item.

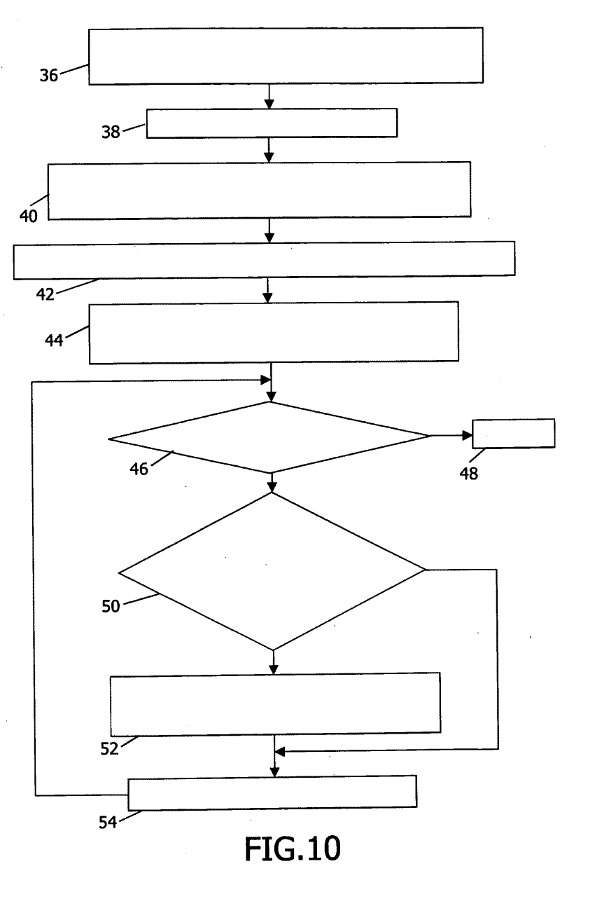

The present invention will now be described with reference to FIG. 10, which is a flow chart of a method according to the invention. The disc 8 is provided with a number of transport streams, wherein the interactive graphics stream IG of the second transport stream TS2 has its groups of buttons set to occur regularly in the stream. This stream is now also denoted a protection stream. At least one button in a group is then also set to automatically perform an action that disturbs the perception of the content in either the video stream V or the audio stream A or both. The UO-T table for each such group of buttons has further been set in the stream so that a user cannot influence the buttons.

First, the control unit 12 retrieves and implements the command structure provided in layers L1, L2 and L3 of FIG. 1 from the disc 8 via the reading unit 20, step 36, such that it can now operate as a playing control unit controlling the presentation of transport streams provided on the disc 8. In the following description, it is assumed that the second movie object MO2, the second play list PL2 and the third play item PI3 are the only parts of the command structure involved in the control of a protection stream IG or a stream to be used for disturbing the perception of the content. However, it should be realized that more movie objects, play lists and play items might be used for this protection. There may also be more protection streams for disturbing the perception of content. The control unit 12 then awaits a user selection via the user interface 14. When a user selection is received, step 38, which user selection is a selection of an item in the index table IT, the control unit 12 selects the movie object associated with the selected table item, which is the second movie object MO2 in this case. This movie object comprises a set stream command, which automatically sets a stream to be played, i.e. the protection stream IG. Thus, the protection stream IG is automatically selected in addition to the user-selected stream, step 40. The control unit 12 then makes the movie object M02 select a play list, which is the second play list PL2 in the current example. Then the control unit 12 sets the user-operating table UO-T associated with the play item that is to control a protection stream so that a user cannot influence the protection stream IG. This is done by setting the appropriate flag associated with the protection stream to disallow changes by the user. In the present example, this is done for the UO-T table of the third play item PI3. The setting is performed by setting the stream change mask associated with the protection stream, step 42. For the third play item PI3, this is the mask CH-PG. Subsequently, the control unit 12 makes the play item PI3 in the second play list PL2 play the second clip C2. Because of the set stream command, it is then ensured that the protection stream IG will be played when the play item starts playing one or more streams in the second transport stream TS2 including the user-selected stream. When a user thus tries to play a first stream in the transport stream TS2, he will also automatically get a second protection stream played in accordance with the setting in the movie object, step 44. This is done by providing the selected streams to respective decoders and showing them on a display and/or providing them to a speaker.

Once the streams have been started playing, the control unit 12 continuously checks if the streams are stopped being played, step 46, and if their playing is ended, step 48. Playing can end because the transport stream has reached the end marker indicated by the play item or because the user has selected to end or halt the playing prematurely. If no end of playing is detected, step 46, the control unit 12 goes on and causes the interactive graphics processing unit 26 to process the protection stream. In the processing operation, the processing unit 26 checks if a group of buttons is found in the protection stream, step 50. If so, these and corresponding other information components such as settings and command scripts are provided to the control unit 12, which in turn goes on and automatically performs or orders the performance of the actions set to at least one of the buttons, step 52, and subsequently orders continued playing of streams, which continuously played streams might be the protection stream together with another stream, which might be the user-selected stream, but may just as well be at least one other stream selected by the performed action. Subsequently, the control unit goes back and investigates if playing is to be ended, step 46. If no buttons are found, step 50, the control unit 12 orders continued playing of the streams that were played before the check was being made.

The different method steps performed are also provided in Table I, shown below.

TABLE I

| | |
|---|---|
| 36 | RETRIEVE AND IMPLEMENT COMMAND STRUCTURE IN |
| | LAYERS L1, L2, L3 OF DISC |
| 38 | RECEIVE USER SELECTION |
| 40 | AUTOMATICALLY SELECT PROTECTION STREAM IN |
| | ADDITION TO USER SELECTED STREAM |
| 42 | DISABLE STREAM CHANGE MASK FOR PROTECTION |
| | STREAM |
| 44 | PLAY USER SELECTED STREAM AND PROTECTION |
| | STREAM |
| 46 | END OF PLAYING? |
| 48 | END |
| 50 | BUTTON FOUND IN PROTECTION STREAM? |
| 52 | AUTOMATICALLY PERFORM ACTION ASSOCIATED WITH |
| | BUTTON |
| 54 | CONTINUE PLAYING STREAMS |

The user thus selects to play at least a first stream, which may be a video stream V or an audio stream A of the transport stream TS2, but is normally a selection to play both simultaneously. However, then the movie object sets the second protection stream to be played in addition to the selected first stream, which protection stream allows the performance of different measures for disturbing the perception of content in the user-selected streams.

Disturbing of the perception of content is realized in a simple way by means of the present invention, using a protection stream created by using an existing stream type provided in a transport stream. In this way, it is possible to avoid the use of additional complex measures for disturbing content. The invention also allows the use of the same transport stream for providing preview and full copies of content, which reduces the production costs of, for instance, portable storage mediums comprising such transport streams. Furthermore, there is great freedom of selecting disturbing measures. Since the measures are provided in an existing transport stream structure, the additional storage space required for such measures is further limited.

The protection stream can provide a number of actions in order to disturb the perception of content in the first stream.

According to a first embodiment of the present invention, a click sound is set to be associated with the selection of a button. In this embodiment, no command script is invoked so that the button is not activated. Note that a UO-T table corresponding to an interactive page this button belongs to may also be set to disallow the selection and/or activation of all buttons on that page. The time-out period is set in such a way that it expires quickly after the presentation time. In this way, user interaction is not possible and the selection is set to be made by default when the time-out period expires. The cycle for the recurring buttons is further set short so that the clicking sound is often produced. This measure disturbs the presentation of user-selected audio. This click sound may also be combined with the presentation of an image associated with the button in order to disturb video that is presented simultaneously.

According to another embodiment of the present invention, the button is set to be automatically activated in the same way as the automatic selection made above and thus to invoke a corresponding command script. This means that, also in this case, the time-out period is set in such a way that it expires quickly after the presentation time and a button is set to be activated by default when the time-out period expires. The command invoked is a set stream command in this case and is set in such a way that it is always automatically invoked by the button in question. This means that, whenever the button appears in the stream, a command script is activated, setting a stream to be played that disturbs the perception of the content.

In this case, the command script can be set to change the stream from a stream being played. In the case of video, the stream being selected may be a certain angle of the video. In this case, the angle is actually not shot from a different camera but video content that is coded with a lower quality. Once the button is found in the protection stream, a change is then made to a different transport stream having the low-quality video. The change is then made through the control unit 12 looking in the status register 18 and checking which video stream is being played If it is not the stream identified by the set stream command, it changes streams. Because of this measure, it is needless for a user to try to change the stream, because the low-quality video would be selected once again within a short period of time if he tried to change the stream. Another possible variation is to constantly switch between different angles of video.

According to another embodiment of the present invention, the protection stream is set to change to a different audio stream, which may be a stream in a language that is different than the normal language or audio having an unintelligible sound. The change is then made through the control unit 12 looking in the status register 18 and checking which audio stream is being played. If it is not the stream identified by the set stream command, it changes streams. In this case, it is also possible to select different audio streams perhaps combined with muting of the sound for different groups of buttons, such that the sound shifts regularly and thus confuses the user.

In one embodiment, the protection stream selects the presentation graphics and text stream as a further protection stream which displays warning messages, such as messages indicating that the content is protected. Another variation is to have said further protection stream provide one or more geometrical shapes such as a rectangle or a triangle, which can also be moved across the ordinary video content.

According to yet another embodiment, a text subtitle stream is used as a further protection stream in such a way that texts for subtitles are chosen to include characters that are most disturbing to a user. In this case, characters of a certain type can be used, such as the Webdings type with maximum font size. The subtitle can then also be set to move across the ordinary video content in order to obtain optimal blocking.

It is also possible to select a further interactive graphics stream for disturbing the perception of content.

The interactive graphics stream itself can be provided in such a way that it blocks or does not block the view. The buttons can thus be made transparent, semi-transparent, non-transparent or animated, and an image may be displayed together with a group of buttons.

It should also be realized that several of the above-mentioned measures can be combined in order to provide different degrees of protection.

There are a number of variations that are possible in relation to the present invention. It is possible to combine a protection stream for a part of a clip together with a normal unblocked presentation for another part. One example of this can be seen in FIG. 1, in which the third play list PL3 includes a fourth play item PI4, which may be an item that is directed towards providing blocking streams, together with a play item, and the fifth play item PI5, which provides unrestricted viewing of content. It is also possible that the protection stream does not disturb the perception of content in some areas, whereas it does in other areas. In this way, it is possible for a user to get unlimited access to some parts of the content together with disturbed content in order to be able to perceive the content for deciding on a purchase or not. Thus, at least a part of a first user-selected media stream gets disturbed by a corresponding part of a second media stream. It is of course also possible to provide protection streams in several clips.

Other variations of the present invention are possible, one such variation being that the movie object does not use a set stream command, but instead a setting in the STN table of the play item, defining a protection stream to be presented.

It has been mentioned above that the selection of playing the protection stream is performed via a setting in a movie object or an STN table. It should be realized that the invention is not limited thereto, but that the control unit in the player could be made to automatically select the protection stream when it starts playing streams, without having to refer to elements of the command structure on the disc such as a movie object or an STN table.

According to the present invention, it is also possible to unlock a disc. If a user has decided to purchase the content, the disc is unlocked, for instance, by the movie object comprising a branching made on the basis of purchase verification. If no purchase is made, the set stream command is set to play the blocking stream, whereas no set stream command is set if a purchase is made. In the case of an STN table setting, a movie object activates play items that have protection streams defined in their STN tables if no purchase is made, and play items in which no such STN settings are made are activated if a purchase is made. The set stream command would then not appear in this unlocking sequence. The unlocking sequence can then also be followed or preceded by a resetting of the UO table for allowing all changes to the content. When an unlocking operation is performed, the control unit can be set to remove all settings made in relation to activation of command scripts in the protection stream or allow a user to remove them from this protection stream. However, it is not possible to remove click sound settings. If the control unit is set to select the protection stream independently of the command structure, the selection of the protection stream is of course removed in the control unit without using said command structure.

The control unit is preferably provided in the form of a processor with an associated program memory, which comprises a program code for fetching the command structure which can be stored for performing the method according to the invention.

However, it is also possible to provide the command structure in the player in advance, perhaps implemented as hardware. The program code may further be provided on a server and downloaded to the multimedia presentation device. The different decoding units and processing units can either be provided in hardware or software or a combination of both.

In the preferred embodiment, the transport stream TS2 with the protection stream is provided on a portable storage medium. However, it may also be provided somewhere else and sent to the player, for instance, from a server. It should therefore be realized that the transport stream may be provided as a signal sent to a player.

The other parts of the player can be implemented in any suitable form including hardware, software, firmware or combinations of these. Especially the decoders and processing units may be provided in hardware. The elements and components of an embodiment of the invention may be physically, functionally and logically implemented in any suitable way. Indeed, the functionality may be implemented in a single unit, in a plurality of units or physically and functionally distributed between different units and processors.

Although the present invention has been described in connection with specific embodiments, it is not intended to be limited to the specific form set forth herein. Rather, the scope of the present invention is limited only by the accompanying claims. In the claims, use of the verb “comprise” and its conjugations does not exclude the presence of other elements or steps. Although individually listed, a plurality of means, elements or method steps may be implemented by e.g. a single unit or processor. Individual features may be included in different claims, but these may be advantageously combined, and the inclusion in different claims does not imply that a combination of features is not feasible and/or advantageous. In addition, singular references do not exclude a plurality. Thus, references to “a”, “an”, “first”, “second”, etc. do not preclude a plurality. Reference signs in the claims are provided merely as a clarifying example and shall not be construed as limiting the scope of the claims in any way.

1. A portable storage medium (8) to be used in a media player (10) for disturbing the perception of content provided in a first media stream (V; A), the medium having stored thereon:
at least one transport stream (TS2) comprising the first media stream combined with at least a second media stream (IG) having at least one embedded user-selectable object (4), wherein the object is set to automatically provide an action disturbing the perception of content in the first stream when the object in the second stream is being processed.

2. A storage medium according to claim 1, wherein the object is set to recur regularly in the second stream.

3. A storage medium according to claim 1, wherein the action is a sound that the object is set to generate when it is being processed in the stream.

4. A storage medium according to claim 1, wherein an embedded command is associated with the selectable object, the action being that the command is set to disturb the perception of content in the first media stream.

5. A storage medium according to claim 4, wherein a user-operation table (UO-T) is provided, which is associated with said object having at least one setting disallowing the change related to removal of said command.

6. A storage medium according to claim 4, wherein the command selects a media stream to be presented in order to disturb the perception of content in the first media stream.

7. A storage medium according to claim 6, wherein the first media stream is a video stream (V), and the command selects a third stream, which is a video stream of the same content with a lower quality.

8. A storage medium according to claim 6, wherein the first media stream is a video stream (V), and the command selects a third stream comprising additional visual information (IG; PG) to be presented across said first stream for disturbing the perception of content in the first media stream.

9. A storage medium according to claim 6, wherein the first media stream is an audio stream (A) which is combined with a video stream, and the command selects a third stream, which is an audio stream to be presented instead of or in addition to the first stream for disturbing the perception of content in the first media stream.

10. A storage medium according to claim 1, further comprising a computer program code which, when loaded in the player, enables said media player to implement
a playing control unit (L1, L2, L3) set to
select, on the basis of user selection of reproducing content provided in the first media stream, the second media stream for being played in relation to the first media stream, and
order the playing of the second media stream in relation to the first media stream.

11. A media player (10) for disturbing the perception of content provided in a first media stream (V; A), said first media stream being combined with at least a second media stream (IG) in a transport stream (TS2), the media player comprising:
a control unit (12) arranged to:
receive a user selection of reproducing content provided in the first media stream,
select the second media stream for presentation together with the first media stream,
determine if there is a user-selectable object (4) in the second stream having an action associated with it, and
at least order automatic performance of the action associated with a user-selectable object found, in order to disturb the perception of content provided in the first media stream.

12. A method of disturbing the perception of content provided in a first media stream (V; A), said first media stream being combined with at least a second media stream (PG) in a transport stream (TS2), the method comprising the steps of:
receiving a user selection of reproducing content provided in the first media stream, (step 40),
selecting the second media stream for presentation together with the first media stream, (step 42),
determining if there is a user-selectable object (4) in the second stream having an action associated with it, (step 50), and
automatically performing the action associated with the user-selectable object found, (step 52), in order to disturb the perception of content provided in the first media stream.

13. A signal for use in a media player that allows disturbing the perception of content provided in a first media stream (V; A), the signal comprising:
at least one transport stream (TS2) comprising the first media stream combined with at least a second media stream (IG) having at least one embedded user-selectable object (4), wherein the object is set to automatically provide an action disturbing the perception of content in the first stream when the object in the second stream is being processed.
